(19) United States
(12) Patent Application Publication
(10) Pub. No.: US 2012/0187177 A1
(43) Pub. Date: Jul. 26, 2012

(54) POWERED NAIL DRIVING TOOL MECHANISM

(76) Inventors: Herman Myburgh, Lascassas, TN (US); Sonette Myburgh, Lascassas, TN (US)

(21) Appl. No.: 13/062,320

(22) PCT Filed: Sep. 9, 2009
(86) PCT No.: PCT/US2009/005061

§ 371 Date: Nov. 21, 2011

Related U.S. Application Data
(60) Provisional application No. 61/136,495, filed on Sep. 9, 2008.

(51) Int. Cl. B25C 1/00

(52) U.S. Cl. 227/120

(57) ABSTRACT

The nail driving tool magazine (10) includes a substantially elongate main body (12) adapted to be selectively attached to a nail driving tool (T). The main body includes at least two nail feed rails (14, 16) open at one end for loading the nails (N). The opposite end is connected to a feed chute (22) directing nails to a nailing chamber (21). Guide tracks (35, 36, 45, 46) are disposed adjacent each feed rail. A spring-loaded feed carriage (30, 40) rides in each guide track to advance the nails. A freely pivoting rail selector (24) is disposed in the feed chute to automatically switch to a full rail when the other rail is spent to selectively direct the nails to the nail driving chamber. In this position, the rail selector blocks the spent rail so that it may be reloaded.

### TECHNICAL FIELD

The present invention relates to fastener driving tools, and more specifically to a nail driving tool magazine configured for maximum storage and dispensing of nails in a convenient, automatic manner.

### BACKGROUND ART

Nail guns and other powered fastening devices are useful tools that provide convenient and faster completion of work with less strain on the user. These types of devices typically include a magazine that holds a plurality of nails or other fasteners. The nails are positively fed to the driver of the device. The driver impacts a nail to drive it into the work.

These magazines each hold a certain capacity of nails or fasteners, which allows for relatively long periods between reloads, a convenience mitigating down time and physical expenditure. Despite these conveniences, the design of these magazines has not been satisfactory. For example, some magazines have several rails to feed the nails, resulting in a relatively wide body not conducive to working in small spaces. Along the same lines, weight imbalances may be present, which causes uncomfortable handling of such devices when being used for long periods of time. Some multi-feed rail magazines may also be overly complex in the mechanisms for holding and feeding the nails, resulting in substantial increased costs of manufacture. Moreover, some must utilize proprietary nails. Due to the issues noted above, it would be a benefit in the art to provide a multi-feed rail magazine with a relatively small or compact form factor, simple in construction and able to utilize both proprietary and non-proprietary nails or nail strips.

Thus, a nail driving tool magazine solving the aforementioned problems is desired.

### DISCLOSURE OF INVENTION

The nail driving tool magazine includes a substantially elongate main body adapted to be selectively attached to a nail driving tool. The main body includes at least two nail feed rails open at one end for loading the nails. The opposite end of the main body is connected to a feed chute directing the nails to a nailing chamber. Guide tracks are disposed adjacent each feed rail. A spring-loaded feed carriage rides along the tracks to advance the nails. A freely pivoting rail selector is disposed in the feed chute to automatically switch to a full rail when the other rail is spent in order to continuously direct nails to the nail driving chamber. In this position, the rail selector blocks the spent rail so that the empty rail may be reloaded.

These and other features of the present invention will become readily apparent upon further review of the following specification and drawings.

### BRIEF DESCRIPTION OF THE DRAWINGS

FIG. 1 is an environmental, perspective view of a nail driving tool magazine according to the present invention.

FIG. 2 is a perspective view of the nail driving tool magazine according to the present invention.

FIG. 3 is a section view taken along lines 3-3 of FIG. 2.

FIG. 4 is a perspective view of the nail driving tool magazine according to the present invention, shown from the side opposite the side shown in FIG. 2.

FIG. 5 is a section view taken along lines 5-5 of FIG. 4.

FIGS. 6A, 6B, 6C, and 6D are top views in section of the nail driving tool magazine according to the present invention, showing various stages and positions of the feed rail selector as the rail selector switches from one feed rail to another.

FIG. 7 is a transverse view in section, similar to FIG. 5, of an alternative embodiment of a nail driving tool magazine according to the present invention, the magazine being configured for top loading of nails.

FIGS. 8A and 8B are opposing side views of another alternative embodiment of a nail driving tool magazine according to the present invention, configured for side loading of nails.

FIG. 9 is a transverse view in section, similar to FIGS. 5 and 7, of a further alternative embodiment of a nail driving tool magazine according to the present invention, the magazine being configured to accommodate specific collated nails or fasteners.

Similar reference characters denote corresponding features consistently throughout the attached drawings.

### BEST MODES FOR CARRYING OUT THE INVENTION

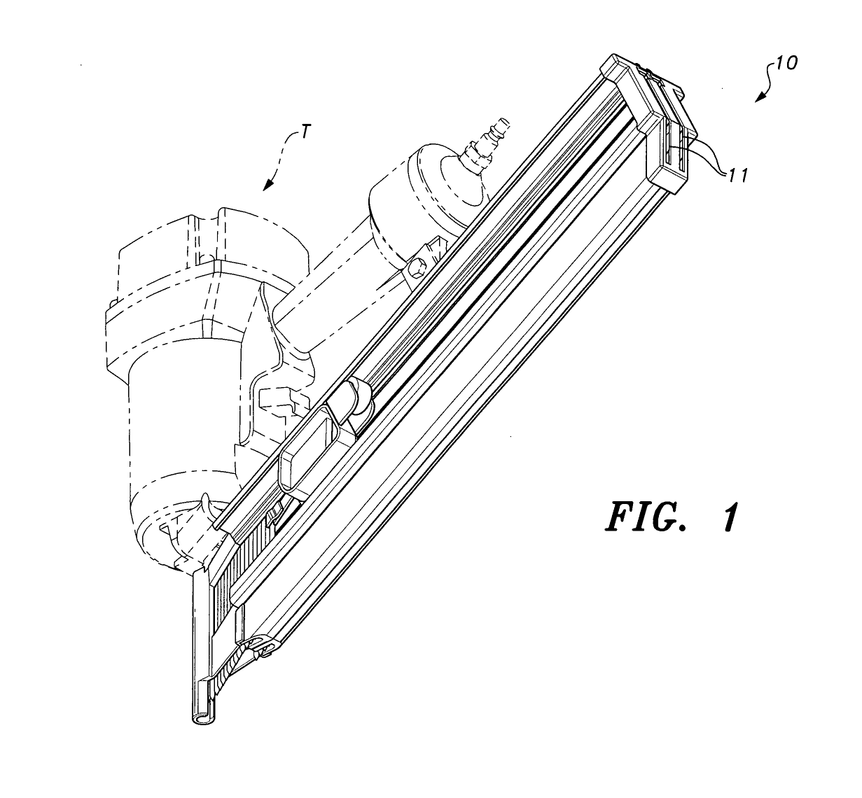

The present invention relates to a nail driving tool magazine, generally referred to by reference number 10, having a relatively compact form and simple construction for delivering nails in a multi-feed rail system. As shown in FIGS. 1-4, the nail driving tool magazine 10 is adapted to be selectively attached to a pneumatic, gas or electrically powered nail gun or tool T. The magazine 10 includes a substantially elongate, hollow rectangular main body 12 having at least a pair of parallel, spaced apart first and second feed rails or tracks 14, 16. Each rail 14, 16 is adapted to hold and guide a plurality of nails, or a nail strip N, to a delivery chute 22 attached to one end of the main body 12. The opposite, distal end of the main body 12 may be open to permit reloading of nails N to the respective feed rails 14, 16. A cap 75 may be mounted to the distal end and may include slots 11 aligned with the first and second feed rails 14, 16. Each slot 11 may be shaped to conform to the outline of a nail to thereby permit self-aligned insertion of nails during loading of a respective rail 14, 16 from the rear of the magazine 10. Moreover, the main body 12 may include an upper attachment rail or track 13 for cooperation with a mounting flange depending from the nail gun T.

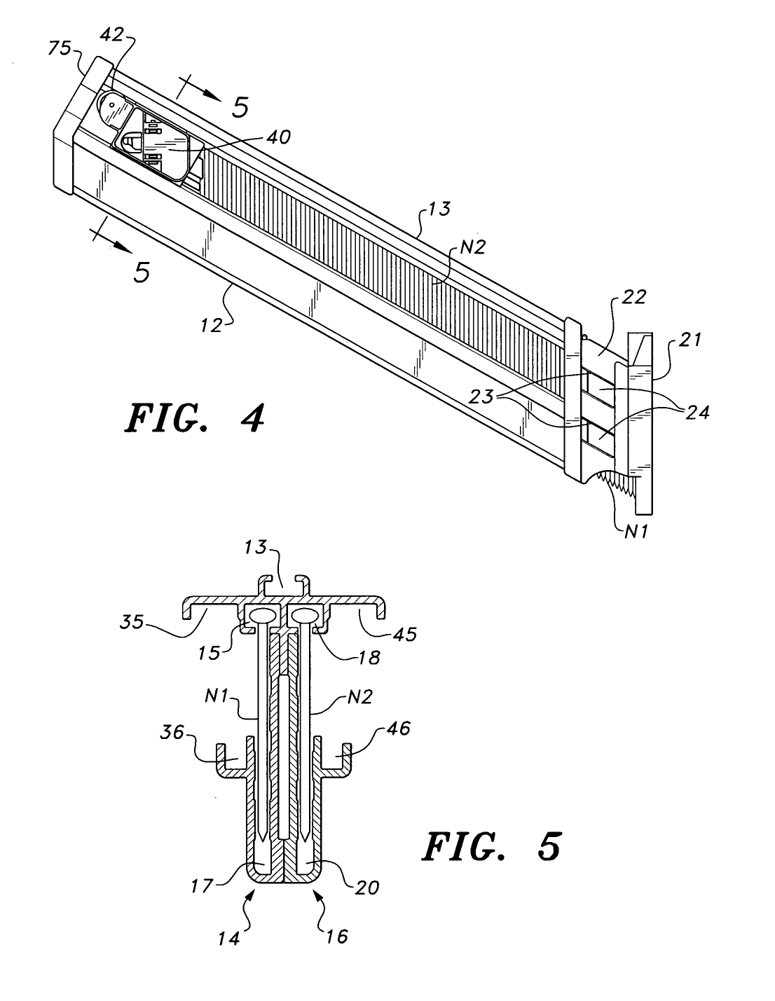

As shown in FIG. 5, an upper trough 15 that is shaped to hold or carry the nail head and a lower trough 17 that is shaped to hold and guide the nail body are defined by the first feed rail 14. Similarly, an upper trough 18 and a lower trough 20 are defined by the second feed rail 16. Each of the upper troughs 15, 18 may be a substantially C-shaped channel running the length of the main body 12 where the shape supports the nail head and defines an opening through which the nail body may pass. Similarly, each of the lower troughs 17, 20 may be formed by a substantially U-shaped channel running the length of the main body 12, with the opening thereof receiving the nail body.

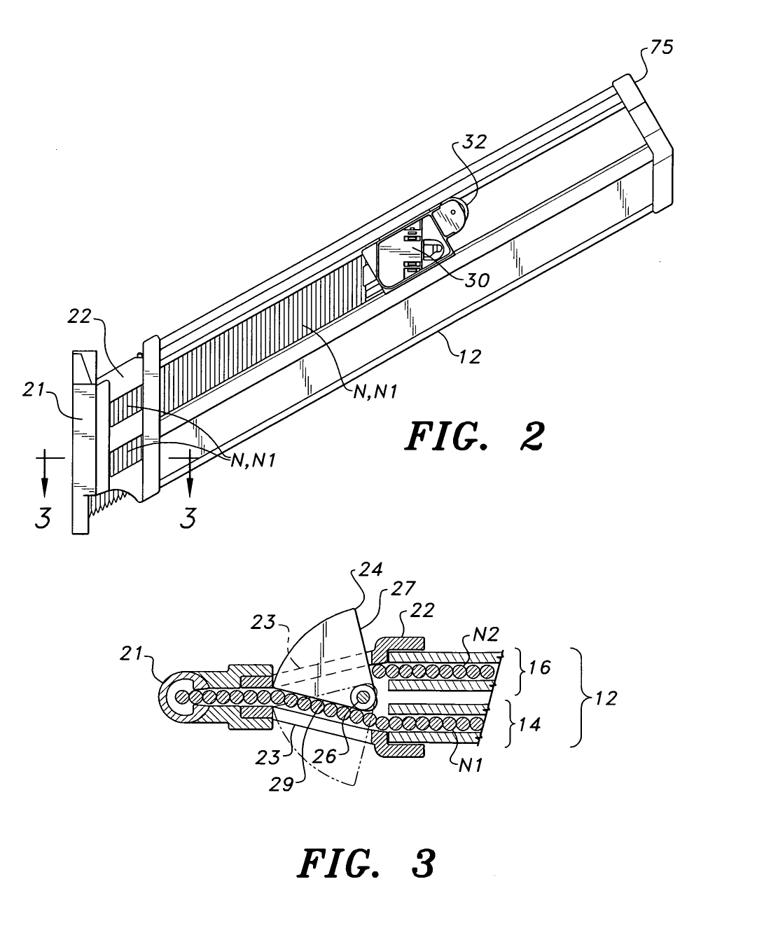

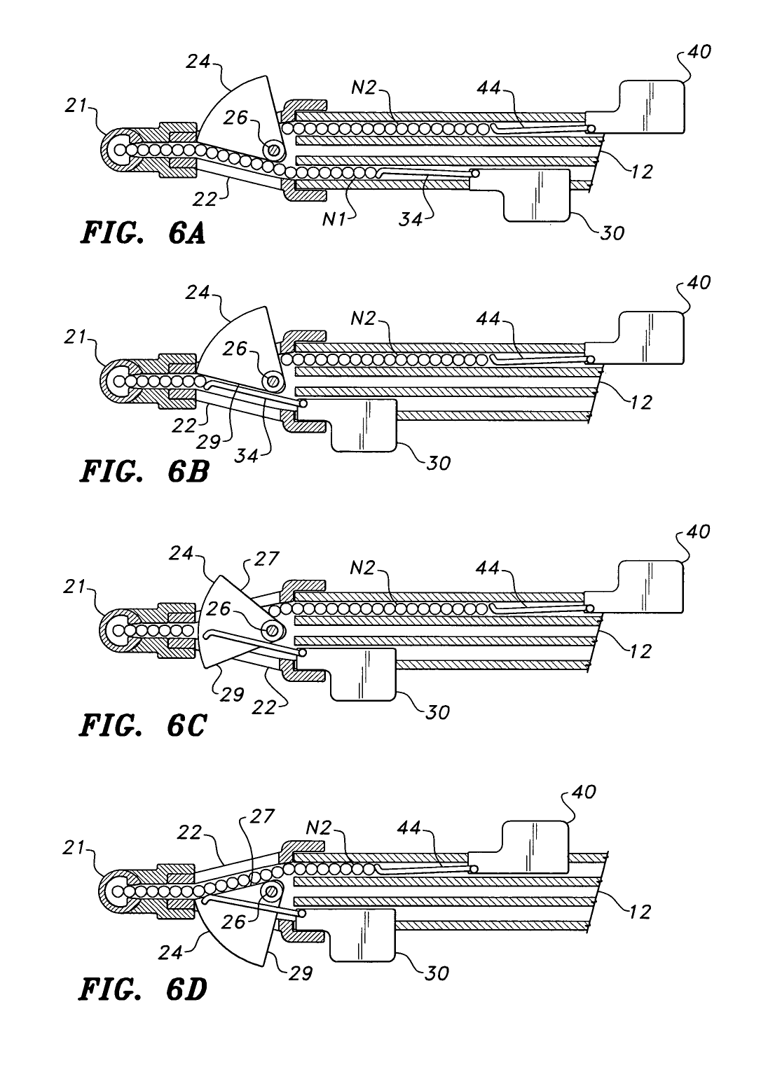

As shown in FIGS. 6A-6D, to positively feed or deliver the nails N, the magazine 10 includes first and second feed carriages or advancing mechanisms 30, 40 for respective feed rails 14, 16. Each feed carriage 30, 40 includes a respective biased pusher or finger 34, 44 that engages the rearmost nail in a nail strip N to push the nails N toward the delivery chute 22. The motive force for the feed carriages 30, 40 may be provided by springs 32, 42, shown in FIGS. 2 and 4, respectively.

The feed carriages 30, 40 ride in tracks formed in the main body 12 adjacent corresponding feed rails 14, 16. Referring to FIG. 5, the first feed carriage track includes first upper channel 35 and first lower channel 36, and the second feed carriage track includes second upper channel 45 and second lower channel 36. In this exemplary embodiment, the springs 32, 42 may be coil springs with one end anchored near the proximal end of the main body 12 inside the respective carriage track, the proximal end being close to the delivery chute 22.

Referring to FIGS. 1-4, the nail delivery chute 22 includes angled sides extending from lateral sides of the main body 12 to funnel nails N1 from the first feed rail 14 or the nails N2 from the second feed rail 16 towards the nailing chamber 21 where an individual nail is acted on by an impact head to drive the nail into a workpiece. The delivery chute 22 also includes a freely pivotal rail selector or gate 24 that automatically blocks delivery of an unused nail strip until the current nail strip has been spent.

With particular reference to FIG. 3, the rail gate 24 may be a substantially angular, arcuate or pie-shaped sector, wedge, or block having straight first and second planar sides 29, 27 defining an arc therebetween. The rail gate 24 is rotatable about pivot 26, which is located adjacent the proximal end of the main body 12. The rail gate 24 may be configured with more than one of these blocks in a stack, each rotatable about the pivot 26. The delivery chute-forming wall(s) 22 includes at least one window or cutout 23 formed therein to permit passage of the rail gate 24 into the rotated positions shown in FIG. 3. It is noted that each window 23 corresponds to each rail gate 24. Depending on which nail strip is in use, the straight sides 27, 29 either block or permit feeding of the nail strip N1, N2 from that respective feed rail 14, 16.

Referring to FIGS. 6A-6D, the drawings show various stages for automatic feed rail selection performed by the rail gate 24. In FIG. 6A, the first nail strip N1 is in use. The rail gate 24 is pivoted to the point where the second straight side 27 blocks feeding of the second nail strip N2 from the second rail 16. The first straight side 29 lines up parallel to one chute-forming wall 22 to allow passage of the first nail strip N1 towards the nailing chamber 21. The combination of the angled side on the delivery chute 22 and the force exerted on the first nail strip N1 by the first feed carriage 30 and the nails therein maintains the rail gate 24 in the current position. In FIG. 6B, the last nail of first nail strip N1 is being fed, maintaining the position of the rail gate 24. Note that the biased finger 34 pivots to conform to the angle of the delivery chute 22 sidewall due to the finger 34 pushing the rearmost nail of the nail strip N1. In FIG. 6C, passage of the last nail from first nail strip N1 opens up space inside the delivery chute 22, permitting pivoting of the rail gate 24 due to the force exerted on the second nail strip N2 by the second feed carriage 40, this force being transmitted to the second straight side 27 of the rail gate 24. Continuous exertion by the second feed carriage 40 forces the rail gate 24 to pivot to the other extreme position shown in FIG. 6D so that the first straight side 29 blocks passage of first feed rail 14 while the second straight side 27 guides and permits flow of the second nail strip N2 through the delivery chute 22. At this point, the first feed rail 14 may be reloaded by pulling the first feed carriage 30 out and inserting a fresh supply of nails or a fresh nail strip.

Thus, it can be seen that the nail driving tool magazine 10 is a relatively simple and compact nail delivery device. The freely pivoting rail gate 24 automatically selects the full feed rail when the other is spent, while permitting reloading of the spent feed rail.

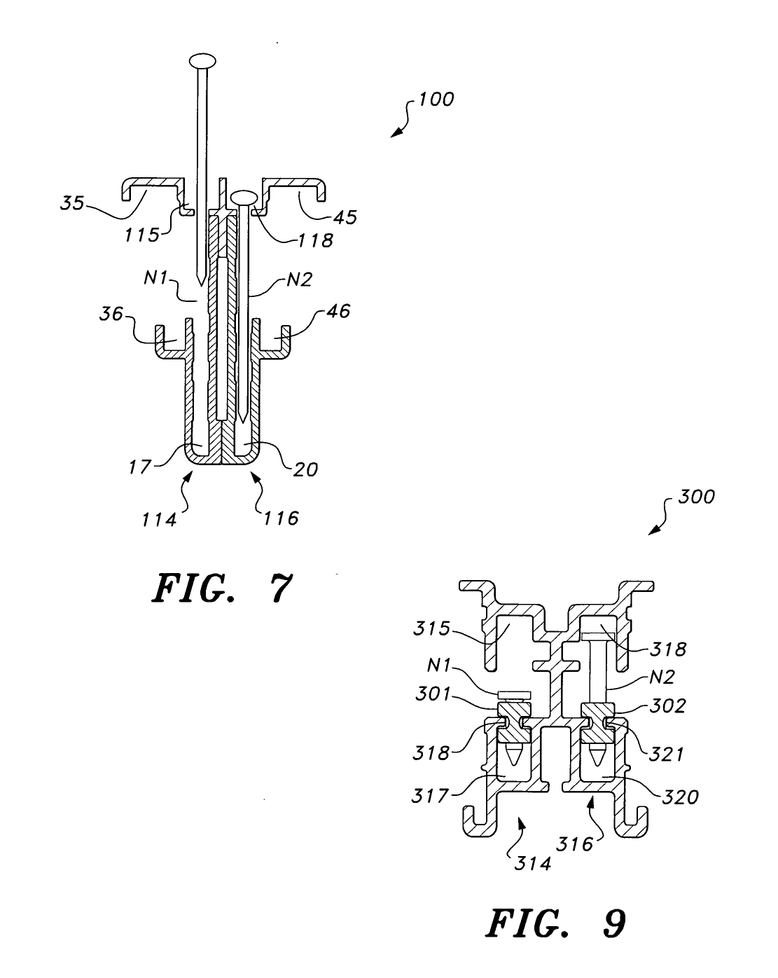

It is to be noted that nail driving tool magazine 10 encompasses a variety of alternatives. For example, the magazine 10 is preferably made from sheet metal but other relatively lightweight, durable materials, such as aluminum, steel, plastic and/or composites, are viable alternatives. Although the above description relates to an angled magazine, the teachings thereof equally apply to straight configured magazines. Moreover, the magazine 10 may include additional feed rails to those mentioned above, as well as provide for top or side loading of nails or nail strips. The nails may be loaded individually or in the form of paper, plastic or wire collated nail strips. Furthermore, the magazine 10 may be of various different colors and/or include indicia for marketing, advertising or personal messaging purposes. Some of the above noted alternatives are shown in FIGS. 7-9.

Referring to FIG. 7, the drawing shows an example of an alternative embodiment of a nail driving tool magazine 100 where nails or nail strips may be fed from the top. The features that define first and second nail feeding rails 114, 116 and the first and second feed carriage tracks remain substantially the same, except for the upper troughs in the first and second nail feeding rails 114, 116. In this embodiment, the first upper trough 115 and the second upper trough 118 are open at the top to permit drop down loading of the nails or nail strips. Each of the upper troughs 115, 118 include a substantially U-shaped channel supporting the head of the nail with a centrally disposed opening permitting the body or shaft of the nails to pass into the lower first and second troughs 17, 20.

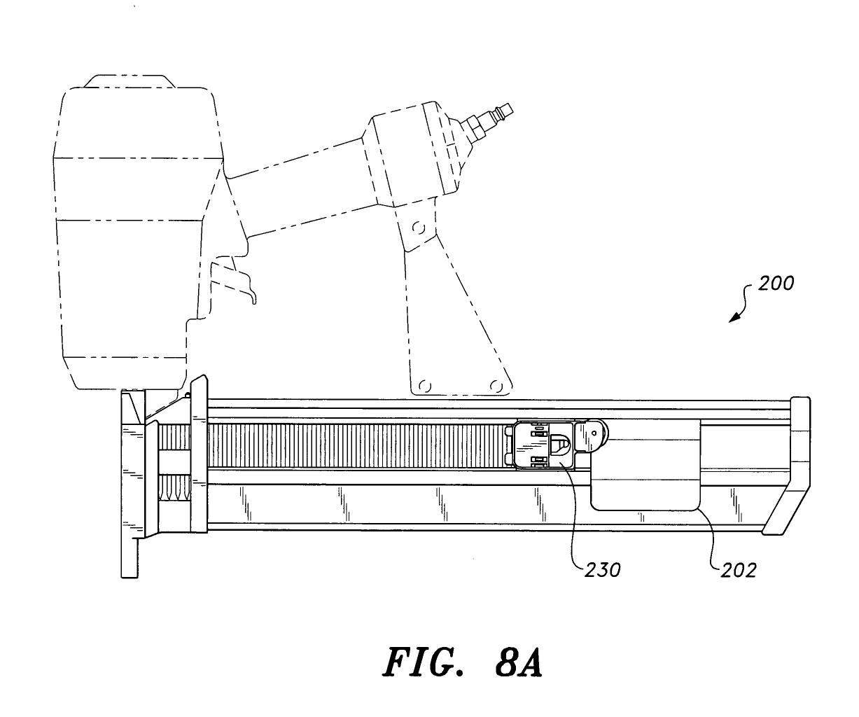

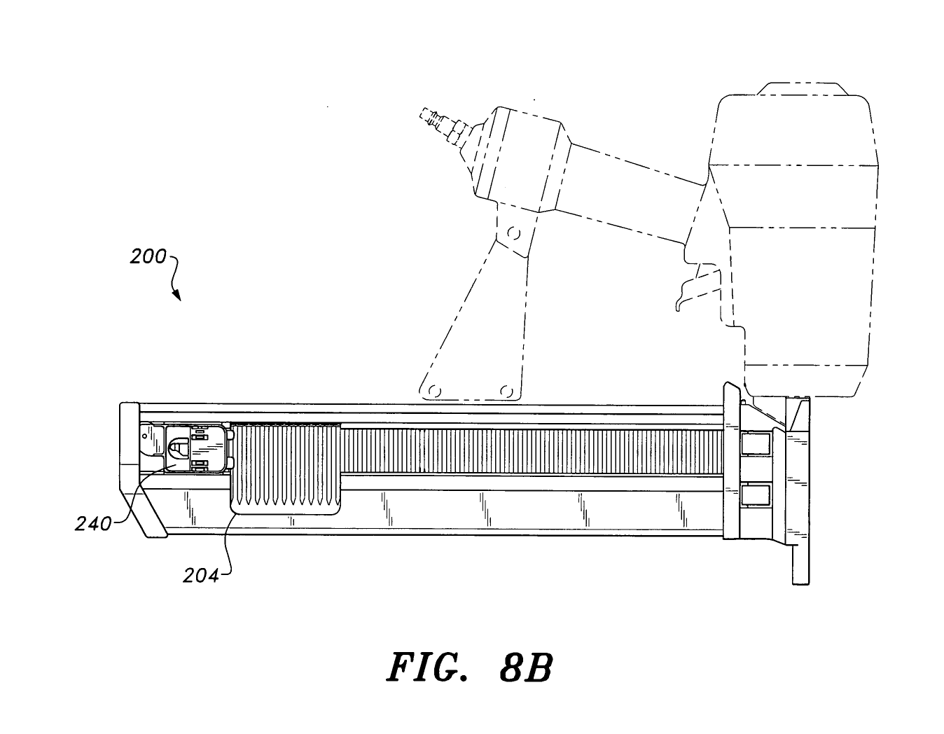

Referring to FIGS. 8A and 8B, the drawings show an example of a straight configured nail driving tool magazine 200 with features for side loading of nails or nail strips. In this embodiment, the nail driving tool magazine 200 is a substantially straight, elongate body having a first loading cutout, hole, window or opening 202 on one side and a second loading cutout, hole, window or opening 204 on the opposite side. Each window 202, 204 may be a substantially rectangular gap providing space for a user to feed or load nails or a nail strip through the window 202, 204 into the respective nail feed rail. Thus, the nails are loaded from the side. Depending on the size of the window 202, 204 and whether a nail strip or individual nails are being fed, the respective nail feed carriage 230, 240 may be repositioned to ensure that the nail strip or nails do not fall out of the window 202, 204. In the case of a nail strip, it may be necessary to allow the tail end or portion of the nail strip to hang out of the window 202, 204 until a sufficient amount of nails have been used so that the remainder may be secured in the respective feed rail.

Referring to FIG. 9, the drawing shows an example of a nail driving tool magazine 300 with features for supporting a collated fastener or nail. In this embodiment, the nail driving tool magazine 300 includes a first nail feed rail 314 and a second nail feed rail 316, both being disposed in a parallel, side-by-side relationship. Each feed rail 314, 315 is adapted to support a variety of different sized nails by their collation, as exemplified by the short nail strip N1 in the first feed rail 314 and the tall nail strip N2 in the second feed rail 316.

The first feed rail 314 may be a substantially C-shaped channel running the length of the main body including an upper trough 315 for housing and supporting the nail head and a lower trough 317 for supporting the nail body by the collation 301. To support the nail body by the collation 301, the lower trough 317 may be a substantially C-shaped sub-channel with an opening 318 defined by the legs of the sub-channel. The opening 318 allows passage of the nail body. The collation 301 is substantially I-shaped in cross section to define engagement grooves on opposite sides of the nail strip N1, whereby each collated strip N1, N2 may be engaged by the respective legs of the sub-channel. The second feed rail 316 is similarly constructed with an upper trough 318 and a lower trough 320 having an opening 321 to allow passage of the nail body and engaging the collation 302 on nail strip N2.

It is to be understood that the present invention is not limited to the embodiments described above, but encompasses any and all embodiments within the scope of the following claims.

I claim:

1. A nail driving tool magazine, comprising:
a substantially elongate main body having a proximal end and a distal end, the main body having a nailing chamber at the proximal end;
at least two nail feeding rails disposed in the main body, each of the feeding rails being adapted for carrying a plurality of nails, each of the feeding rails having an opening defined in the main body for loading the nails;
a feeding carriage disposed adjacent each feeding rail for positively feeding nails toward a driver of a nail driving tool;
a delivery chute disposed at the proximal end of the main body adapted for feeding the nails to the nailing chamber; and
an automatic rail selector for selectively feeding the nails from a first one of the feeding rails at a time and automatically feeding from the other rail when the first rail is empty.

2. The nail driving tool magazine according to claim 1, wherein the at least two nail feed rails comprises a first feeding rail and a second feeding rail centrally disposed in the main body in a side by side relationship.

3. The nail driving tool magazine according to claim 2, wherein the first feeding rail comprises a first upper trough for carrying the head of the nails and a first lower trough for guiding the body of the nails.

4. The nail driving tool magazine according to claim 3, wherein the first upper trough includes an open top for top loading of nails.

5. The nail driving tool magazine according to claim 3, wherein the first lower trough includes laterally extending legs forming an opening, the opening allowing passage of the nail body and the legs adapted to slidably support a collated strip of nails.

6. The nail driving tool magazine according to claim 3, wherein the second feeding rail comprises a second upper trough for carrying the head of the nails and a second lower trough for guiding the body of the nails.

7. The nail driving tool magazine according to claim 6, wherein the second upper trough includes an open top for top loading of nails.

8. The nail driving tool magazine according to claim 6, wherein the second lower trough includes laterally extending legs forming an opening, the opening allowing passage of the nail body and the legs adapted to slidably support a collated strip of nails.

9. The nail driving tool magazine according to claim 2, wherein the main body includes an enlarged loading window on opposite lateral sides and adjacent the rear of the main body for loading nails from either side.

10. The nail driving tool magazine according to claim 1, further comprising a carriage track for each said feeding carriage, the carriage track being defined by the main body and disposed adjacent each said feeding rail for slidable movement of the respective carriage.

11. The nail driving tool magazine according to claim 10, wherein each said feeding carriage comprises:
a bias means for urging positive movement of the feeding carriage; and
a pusher slidable along the respective rail for engaging and pushing the nails towards the delivery chute.

12. The nail driving tool magazine according to claim 11, wherein the bias means comprises a spring.

13. The nail driving tool magazine according to claim 1, wherein the delivery chute comprises angled sidewalls funneling nails toward the nailing chamber, at least one cutout being formed in each of the sidewalls.

14. The nail driving tool magazine according to claim 13, wherein the automatic rail selector comprises at least one substantially angular sector pivotal about a pivot, the angular sector having first and second planar sides and an arcuate side therebetween.

15. The nail driving tool magazine according to claim 14, wherein the first and second planar sides alternately block and permit flow of nails from the at least two feeding rails one rail at a time, one of the rails being blocked until the other is empty, depending upon the pivot angle of the automatic rail selector.

16. The nail driving tool magazine according to claim 1, wherein the automatic rail selector comprises a wedge-shaped body pivotally attached to said main body in the delivery chute, the wedge-shaped body having first and second planar sides and an arcuate side therebetween.

17. The nail driving tool magazine according to claim 1, further comprising a cap disposed on the rear end of the main body.

18. The nail driving tool magazine according to claim 17, wherein the cap defines a nail shaped opening corresponding to each feed rail for loading nails from the rear of the main body.

19. The nail driving tool magazine according to claim 1, wherein the distal end of the main body defines an opening at each of the rails, the openings being dimensioned and configured for feeding the nails therethrough, whereby the magazine is end loading.

20. A fastener magazine, comprising:
a substantially elongate main body, the main body having a parallel pair of feed tracks adapted for carrying a plurality of fasteners and a pair of advance tracks defined adjacent the feed tracks;
an advance mechanism riding in each of the advance tracks for positively feeding the fasteners;
a delivery chute attached to one end of the main body for funneling the fasteners to a driver; and
an automatic pivoting feed track gate for alternate block and flow of fasteners from one of the feed tracks at a time, the gate blocking the flow of fasteners from one of the tracks until the other track is empty.
